(19) United States
(12) Patent Application Publication
(10) Pub. No.: US 2026/0038021 A1
(43) Pub. Date: Feb. 5, 2026

(54) DYNAMIC AUTOMATED RECOMMENDER SYSTEM WITH TUNABLE RECOMMENDATION DISTRIBUTIONS

(71) Applicant: INTUIT INC., Mountain View, CA (US)

(72) Inventors: Shankar SANKARARAMAN, Burlingame, CA (US); Zhao HU, Fremont, CA (US); Nan JIANG, Mountain View, CA (US)

(21) Appl. No.: 18/789,869

(22) Filed: Jul. 31, 2024

(51) Int. Cl. G06Q 30/0601

(52) U.S. Cl. CPC G06Q 30/0631

(57) ABSTRACT

The present disclosure provides techniques for automatically recommending information with a tunable recommendation distribution. One example method includes receiving, for a plurality of users, recommendation scores of a plurality of items generated using a recommender system based on one or more metrics, generating a binary recommendation array based on the recommendation scores, receiving an objective function associated with the recommendation scores and the binary recommendation array, receiving a set of constraints associated with the plurality of users or the plurality of items, wherein the set of constraints comprises a target recommendation frequency range for an item of the plurality of items, updating the binary recommendation array based on evaluating the objective function subject to the set of constraints, and recommending, to each user of the plurality of users, one or more items of the plurality of items based on the updated binary recommendation array.

### INTRODUCTION

Aspects of the present disclosure relate to automatically recommending information in a dynamic manner with a tunable recommendation distribution.

More and more users rely on recommendations to purchase goods or services. Recommendations are often generated based on past interactions, such as the purchase history or interests, of users. The recommendations can help users discover products or services better suited to the needs of the users, such as a product of better quality or a pair of products often used together (e.g., a cooler paired with ice packs).

However, existing recommender system techniques, such as collaborative filtering, content-based filtering, or reinforcement learning, often closely trace the preferences of a user and seldom recommend information in a category when the user does not show a preference in the category. As such, the recommendations made often do not fully capture what the user might be interested in, and can sometimes expose users to harmful and/or false information. Sometimes, it may be desired to increase or decrease the frequency with which some items are recommended, and manual rules are almost always incorrectly applied along with recommendation algorithms, resulting in sub-optimal performance and exposing users to irrelevant information.

Accordingly, improved systems and methods are needed for automatically recommending information in a manner that better corresponds to preferences of users and/or desired frequencies of recommendations for certain items.

### BRIEF SUMMARY

Certain embodiments provide a method for dynamically recommending information with a tunable recommendation distribution.

The method generally includes receiving, for a plurality of users, recommendation scores of a plurality of items generated using a recommender system based on one or more metrics, wherein the one or more metrics include a click-through rate or an expected amount of purchase, generating a binary recommendation array based on the recommendation scores, wherein the binary recommendation array indicates whether or not to recommend the one or more items using binary recommendations, receiving an objective function associated with the recommendation scores and the binary recommendation array, receiving a set of constraints associated with the plurality of users or the plurality of items, wherein the set of constraints comprises a target recommendation frequency range for an item of the plurality of items, updating the binary recommendation array based on evaluating the objective function subject to the set of constraints, and recommending, to each user of the plurality of users, one or more items of the plurality of items based on the updated binary recommendation array.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of the various embodiments.

### BRIEF DESCRIPTION OF DRAWINGS

The appended figures depict certain features of the various aspects described herein and are not to be considered limiting of the scope of this disclosure.

FIG. 1 depicts an example recommender system for dynamically recommending information with a tunable recommendation distribution.

FIG. 2 depicts an example process for optimizing recommendations.

FIG. 3 is a flow diagram of example operations for dynamically recommending information with a tunable recommendation distribution.

FIG. 4 depicts an example application server related to embodiments of the present disclosure.

### DETAILED DESCRIPTION

Aspects of the present disclosure provide apparatuses, methods, processing systems, and computer-readable mediums for automatically recommending information in a dynamic manner with a tunable recommendation distribution.

Users are presented with a wide range of recommendations every day. However, the recommendations usually closely track the past directly indicated interests or preferences shown by the users. Useful information not directly related to the past interests or preferences is rarely recommended to the users.

Certain existing approaches for automated recommendations, such as reinforcement learning based recommendation systems, may enable recommendations of useful information via exploration (e.g., as formulated in multi-armed bandit problems). However, such approaches still may not explore enough and may miss opportunities to recommend useful information that is not directly related to past interests of users, resulting in inefficiencies and inconveniences for the users. Furthermore, such existing approaches do not factor in preferences for certain items or types of items to be recommended more or less frequently than other items or types of items.

Embodiments described herein provide improved automated recommendations through downstream processing of recommendation scores generated using existing techniques. For example, recommendation scores can be received from an upstream recommendation system. A recommendation score may represent the likelihood of one or more items to be recommended to one or more users. Existing approaches would recommend items directly based on the likelihoods. However, the recommendation scores can serve as a basis for further optimization to recommend information to users in a more dynamic and tunable manner.

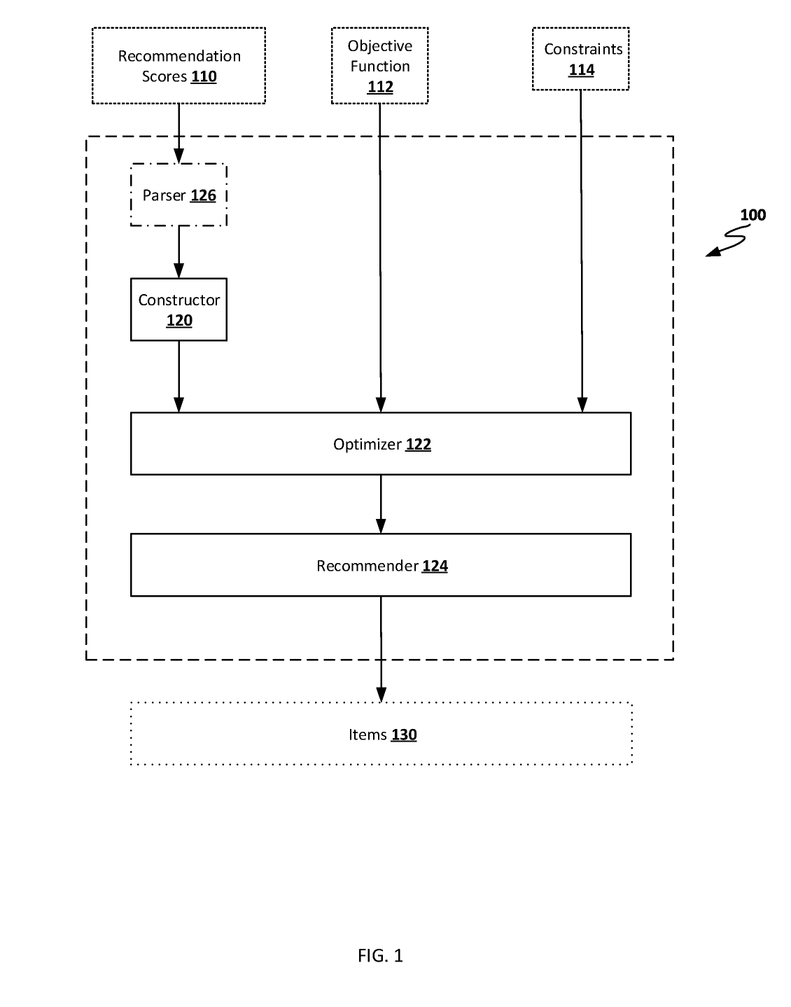

If the number of users is too large (e.g., meeting a threshold), the optimization can be performed with respect to a specific group of users (e.g., sharing a set of common attributes) or aggregated groups of users (e.g., represented by a proxy for each group). If the number of users in a group is still too large (e.g., still meeting the threshold), users in a group can be sampled to reduce the complexity of the optimization. Users in a group can be recommended the same set of items as the proxy for the group. Details regarding optimization with respect to a specific group of users or aggregated groups of users can be found below with respect to FIG. 1.

A binary recommendation array can be generated based on the recommendation scores (e.g., to have the same dimensions as the recommendation scores) to represent an initial guess of whether or not each item would be provided to each user or each group of users (e.g., as represented by each proxy).

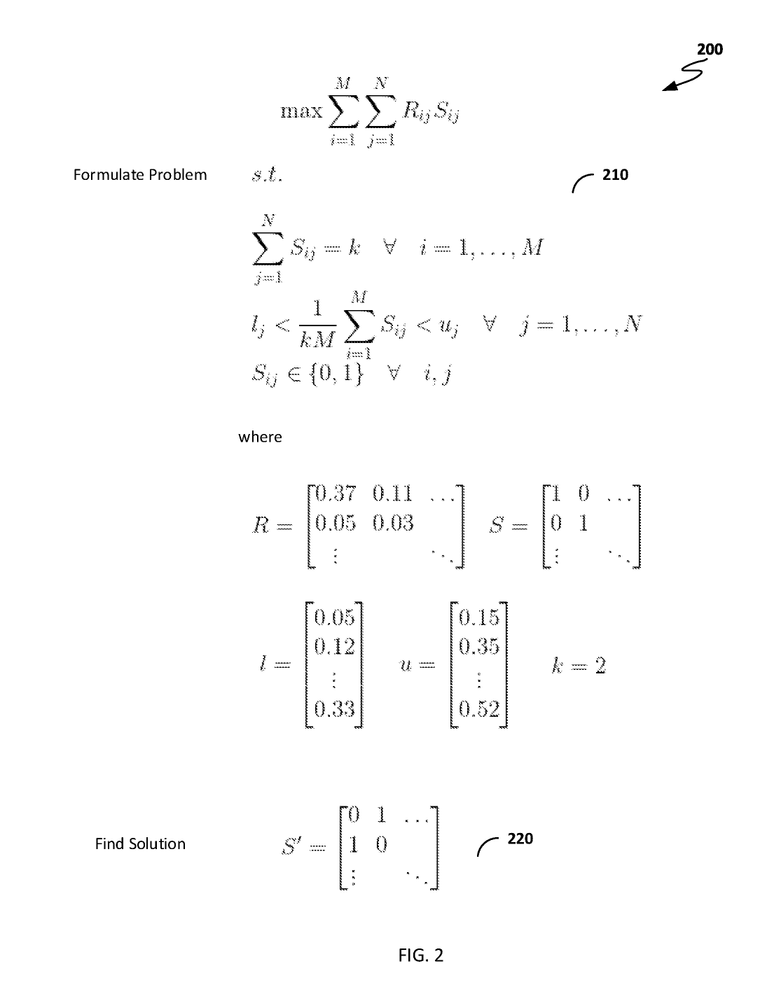

An objective function for the optimization and a set of constraints can be used to establish an optimization problem based on the recommendation scores and/or the binary recommendation array. The recommendation scores can be regarded as the constant while the binary recommendation array can be regarded as the variable in the optimization setting. The objective function may specify to find the best alignment between the recommendation scores and the binary recommendation array whereas the set of constraints may regulate the frequency of recommendations of each item for each user or each group as well as across the users or the groups. Details regarding the objective function and constraints can be found below with respect to FIGS. 1-2.

The optimization problem can be solved using appropriate solvers (e.g., for linear programming or convex optimization problems), and the solution can be an updated binary recommendation array. Items can then be recommended to individual users or to groups of users based on the solution to the optimization problem. Compared to the recommendations of items made based purely on the recommendation scores received, the recommendations of items after the optimization will satisfy a desired range of likelihoods for each item to be recommended (e.g., the desired range may be a tunable constraint in the optimization problem) and hence corresponds to a tunable recommendation distribution. Details regarding finding the updated binary recommendation array as the solution and recommending items based on the updated binary recommendation array can be found below with respect to FIGS. 1-2.

By optimizing based on the output from an upstream recommendation system, techniques described herein overcome deficiencies in existing techniques for computer-based recommendation of information. For example, while existing techniques may not perform a significant amount of exploration with respect to recommending items that a user has not directly shown interest in, techniques described herein allow a computing application to recommend items that would be useful to a user but that the user has not directly shown interest in with much higher likelihoods, increasing the chances for a user to discover and utilize such useful items. On the other hand, the optimized recommendations produced using techniques described herein also help providers of products or services better reach out to potentially interested users by allowing such users to discover items that may otherwise be much less likely to be recommended, thereby increasing efficiencies while reducing time waste in time and resources. Furthermore, unlike existing recommender systems, techniques described herein enable automated recommendations that are dynamically generated for users while also corresponding to desired frequencies with which providers would like certain items or item types to be recommended, resulting in a more tunable automated recommender system that maintains dynamic accuracy. Rather than using manual rules that are statically applied and generally produce suboptimal results, techniques described herein enable customizable relative frequencies of item recommendations to be achieved in an automated and dynamic manner through tunable constraints of an optimization problem. Thus, embodiments of the present disclosure provide a technical improvement with respect to conventional techniques for automatically recommending information.

### Example Adjuster for Optimized Automated Recommendations

FIG. 1 depicts an example adjuster 100 for automatically recommending information with a tunable recommendation distribution. Adjuster 100 can receive recommendation scores 110, objective function 112, and constraints 114 as inputs and generate items 130 as the output. Adjuster 100 can be deployed either online or offline.

A recommendation score 110 may indicate, for a given user, a likelihood for a particular item to be recommended to the user. Recommendation scores 110 can be represented using appropriate data structures, such as an array, a matrix, a dictionary, a nested list, and/or the like.

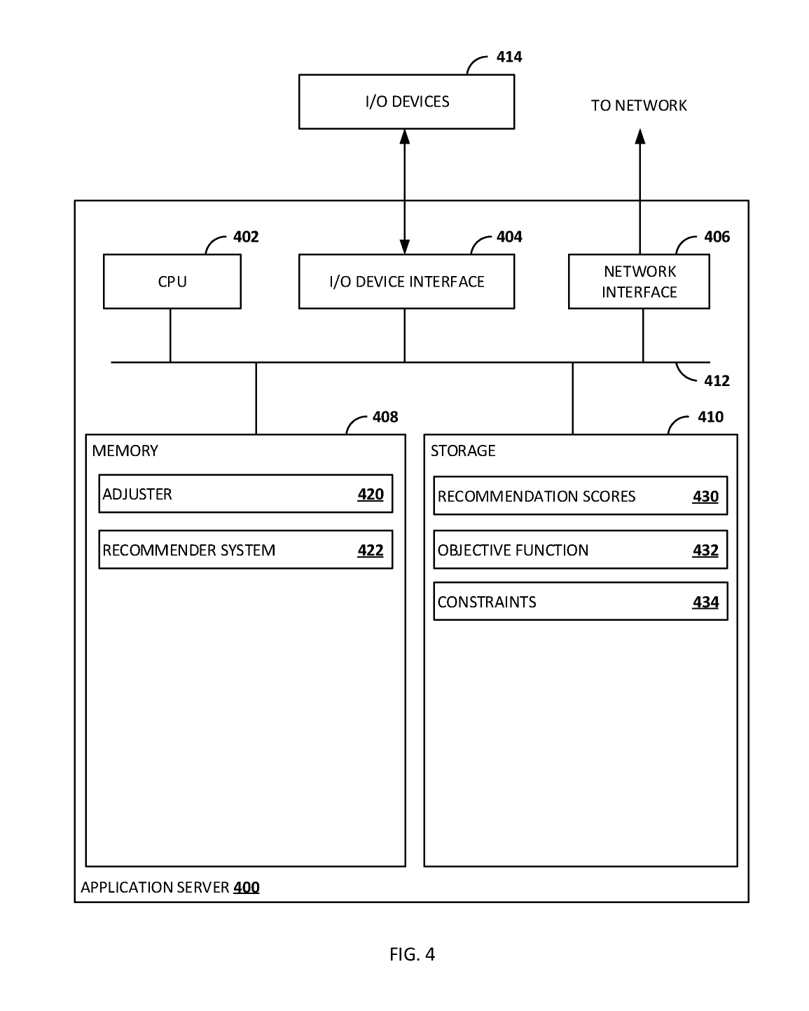

Recommendation scores 110 may be generated using a recommender system (e.g., recommender system 422 of FIG. 4, described below) based on one or more metrics. The recommender system can be one or more of a collaborative filtering model, a content-based filtering model, or a reinforcement learning based model. The one or more metrics can include a click-through rate or an expected amount of purchase. In an example, the recommender system is trained using reactions (e.g., clicking, liking, disliking, sharing, wish listing, making a subsequent purchase, inactivity, etc.) by users toward items (e.g., goods, services, texts, videos, audios, etc.) as input training data while using as the labels an indicator function of whether the users have met a predefined click through rate or a predefined expected amount of purchase. It is noted that these types of recommendation systems are included as examples, and techniques described herein may be used to generate optimized recommendations based on recommendation scores 110 determined using a variety of different types of recommendation systems. More generally, recommendation scores 110 may be generated by one or more components that output likelihoods that one or more items are relevant to one or more users based on attributes related to the items and/or the users.

Recommendation scores 110 can be provided as inputs to constructor 120 to generate a binary recommendation array. As described in more detail below, recommendation scores 110 may optionally be provided first to a parser 126, and then an output from parser 126 may be provided to constructor 120. Constructor 120 may generate a binary recommendation array having the same dimensions (e.g., corresponding to the number of users and the number of items, respectively) as recommendation scores 110. A binary recommendation in the binary recommendation array may represent whether or not a specific item would be relevant to a particular user. In some examples, constructor 120 generates the binary recommendation array with the same data structure as recommendation scores 110.

Objective function 112 may specify a target for a function of recommendation scores 110 and/or the binary recommendation array. The target for the function may specify to seek a best alignment between recommendation scores 110 and the binary recommendation array. For example, the objective function 112 may indicate a maximum of a sum of each recommendation score 110 and the corresponding binary recommendation in the binary recommendation array.

Constraints 114 may indicate a set of limitations that any potential solution has to satisfy. For example, constraints 114 can specify a limitation on the number of items to be recommended to each user, or a desired range of likelihoods for each item to be recommended to the users (e.g., a tunable recommendation distribution, which may be specified by a provider). For example, constraints 114 may include a target recommendation frequency range for a given item that indicates a lower bound and an upper bound of the range (e.g., indicating that the desired frequency with which the given item is to be recommended is between the upper bound and the lower bound). The desired (or target) range of likelihoods for each item in constraints 114 can regulate the frequency of the items appearing in the recommendations to the users and help make the final recommendations better correspond to a tunable recommendation distribution.

In some examples, the desired range of likelihoods for each item to be recommended to the users scales with (e.g., linearly) the number of items to be recommended to each user. In an example, the desired range of likelihoods for an item is from 0.35 to 0.5 when only one item is to be recommended to each user, and the desired range of likelihoods for the item is from 0.7 to 1 when two items are to be recommended to each user.

Recommendation scores 110, the binary recommendation array, objective function 112, and constraints 114 can be provided as inputs to optimizer 122. Optimizer 122 can first formulate a problem based on recommendation scores 110, the binary recommendation array, objective function 112, and constraints 114. The problem may be an optimization problem (e.g., a linear programing problem, a convex optimization problem, and/or the like) where recommendation scores 110 are treated as a set of constants and the elements of the binary recommendation array are treated as the variables. The solution may be an updated binary recommendation array. In other words, the binary recommendation array is an initial guess of whether each item would be recommended.

In some examples, optimizer 122 imposes further constraints not specified by constraints 114 based on the characteristics of or requirements for the problem and/or the solution. For example, optimizer 122 can impose an additional constraint to force the solution to remain binary.

Optimizer 122 can then find a solution (e.g., an updated binary recommendation array) for the formulated problem. The solution may be found by optimizer 122 using one or more solvers, including those that can be used to solve optimization problems, such as a multiprecision polynomial solver (MPSolver), a constraint programming solver using satisfiability methods (CP-SAT solver), a routing solver, or a stochastic gradient descent (SGD) solver.

In some examples, it is desired to have a fine-grained solution where the solution (e.g., the binary recommendation array) indicates at most one item to be recommended to each user, and in these cases optimizer 122 may be run once. In other cases, where it is desired to recommend multiple items to each user, optimizer 122 can be run recursively. In some examples, when there are multiple items to be recommended to each user, optimizer 122 treats the number of items to be recommended as the number of iterations. For each iteration, optimizer 122 can find a solution that indicates, for each user, an item to be recommended via an updated binary recommendation. Then optimizer 122 can add a new constraint specifying that the updated binary recommendation and its associated recommendation score are to remain zero for the next iteration. The new constraint modifies the formulated problem to ignore the item to be recommended in the current iteration, so as to prevent the first item from being recommended in subsequent iterations. Once the iterative process ends, the solutions can be aggregated (e.g., via addition) so as to generate the updated binary recommendations.

Details regarding formulating a problem using the recommendation scores 110, the binary recommendation array, objective function 112, and constraints 114 as well as finding an updated binary recommendation array as a solution to the problem can be found below with respect to FIG. 2.

The solution found (e.g., the updated binary recommendation array) can be provided as inputs to recommender 124 to recommend items 130 to the users, based on the updated binary recommendation array. For example, if the binary recommendations in the updated binary recommendation array indicates to recommend item A and item B to a user, recommender 124 can recommend item A and item B to the user. Items 130 recommended to the users follow the desired range of likelihoods for each item in constraints 114, provides more dynamic and tunable results than the recommendations made based on recommendation scores 110 alone.

Given the sheer number of users (e.g., tens of millions of users) and/or the number of items (e.g., tens of thousands of items), solving the problem directly may require extended amount of time and considerable computing resources. Therefore, to simply the problem, it is useful to adopt a divide-and-conquer approach by optimizing for a specific group of users or aggregating different groups of users, thereby greatly reducing the amounts of computing resources and time required.

In a divide-and-conquer approach, recommendation scores 110 can first be provided as inputs to parser 126. Parser 126 may receive additional commands (e.g., via flags, parameters, etc.) regarding whether to optimize for a particular group of users or to aggregate groups of users as well as user information. User information may indicate attributes (e.g., locations, age group, income group, etc.) of different users. In some examples, user information may already be included (e.g., as metadata) in recommendation scores 110.

Parser 126 may first identify different groups of users. The groups of users can be identified based on a set of attributes of the users (e.g., users with age less than 45 and with location in suburban areas) or using a clustering algorithm (e.g., K-means, Density-based spatial clustering of applications with noise (DBSCAN), and so on).

In some examples, there is still a large number of users in each group and the optimization may still require considerable computational resources. As such, parser 126 may sample a subset of users for a group (e.g., when the number of users in the group meets a threshold), and then exclude, for the group, recommendation scores corresponding to users not in the subset from recommendation scores 110. The sampling can help reduce computational load required for the optimization.

To optimize for a particular group, parser 126 may then identify the particular group (or a sampled subset of the particular group) and exclude recommendation scores corresponding to the users not in the particular group from recommendation scores 110.

Alternatively, to aggregate different groups of users, parser 126 may first aggregate (e.g., compute an average), for each group, associated recommendation scores in recommendation scores 110. In an example, recommendation scores 110 are represented as a matrix with rows corresponding to users and columns corresponding to items. The rows corresponding to users in Group A can be aggregated to generate a vector where each entry of the vector represents an average (e.g., a mean, a median, and/or the like) likelihood of an item to be recommended to users in Group A. In other words, the aggregated recommendation scores associated with group A can characterize a proxy (e.g., a virtual group representative) for all users in Group A.

As such, constructor 120 may then generate a binary recommendation array, as discussed above. The aggregated recommendation scores and the binary recommendation can then be used by optimizer 122 instead to formulate a problem and find an updated binary recommendation as a solution. A binary recommendation in the binary recommendation array or the updated binary recommendation array may represent whether or not a specific item would be relevant to a particular group (e.g., via the proxy), rather than to individual actual users in the group.

Users in the same group may be assigned the same updated binary recommendation array that corresponds to the aggregated updated binary recommendation array associated with the group (e.g., for the proxy). In other words, the updated binary recommendation array corresponding to a group (e.g., for the proxy) may be shared by all users in the group. As such, users in the same group may be recommended an identical set of items 130.

Items 130 may be recommended to one or more users through a variety of methods, such as displaying recommendations via a user interface, transmitting the recommendations via email or text message, and/or the like.

### Example Process for Recommendation Optimization

FIG. 2 depicts an example process 200 for recommendation optimization. Process 200 can be carried out by a recommender system, such as adjuster 100 as shown in FIG. 1.

As depicted, process 200 starts by formulating problem 210. Problem 210 includes matrices R and S, an objective function, vectors l and u, as well as parameter k. In this example, problem 210 is a specific linear programming problem, though other types of optimization problems (e.g., convex optimization problems) may be formulated. Formulating problem 210 can be performed by an optimizer, such as optimizer 122 as shown in FIG. 1.

Matrix R can represent a set of recommendation scores, such as recommendation scores 110 as shown in FIG. 1. Matrix S can represent a binary recommendation matrix, such as a binary recommendation matrix generated by a constructor, such as constructor 120 as discussed with respect to FIG. 1. Although R and S are represented using matrices, they can be represented using other appropriate data structures, such as an array, a dictionary, a nested list, and/or the like.

In this example, matrix R is an M x N matrix where its M rows represent M users or M groups while its N columns represent N items, and each entry of matrix R represents a likelihood for an item to be recommended to a user or a group of users, as discussed with respect to FIG. 1. The constructor can then generate matrix S based on the dimensions of matrix R, so that matrix S is also an M x N matrix where its M rows represent M users or M groups while its N columns represent N items, and each entry of matrix S is a binary indication of whether to recommend an item for a user or a group of users, as discussed with respect to FIG. 1.

In this example, the objective function specifies to maximize the sum of the entries of the elementwise product of R and S, where R is treated as a constant and S as the variable, as discussed with respect to FIG. 1. The objective function here can be an example of objective function 112 as shown in FIG. 1.

In this example, vector l represents a lower bound of the desired range of likelihoods for each item to be recommended to the users, while vector u represents an upper bound of the desired range of likelihoods for each item, as discussed with respect to FIG. 1. Parameter k may represent the number of items to be recommended to each user. In this example, k is 2. Vectors l and u as well as parameter k can represent constraints, such as constraints 114 as shown in FIG. 1.

Additionally, the optimizer may impose additional constraints related to the characteristics of or requirements for the problem and/or the solution that are not specified by constraints it receives from the inputs. In this example, S has to remain binary, and the optimizer can add (e.g., append) an additional constraint to enforce the binary nature of S, as depicted by the last constraint in problem 220, even though no such constraints were received.

In this example, the optimizer solves the problem directly with two items to be recommended to each user or each group. In some examples, alternatively, the optimizer may impose an additional constraint specifying that a solution indicates at most one item to be recommended, and the optimizer can solve the problem recursively through a number of iterations, impose new constraints to ignore a recommended item found in subsequent iterations, and aggregate the solutions in the iterations to generate a final solution, as discussed with respect to FIG. 1.

Solution 220 to problem 210 can be found by the optimizer. In this example, solution 220 is represented as matrix S', which is an updated matrix S (e.g., with the same dimensions as matrix S but with updated entries). Matrix S' can be used to recommend items for users or groups by a recommender, such as recommender 124 as shown in FIG. 1. In this example, item 2 is recommended to user 1 or users in group 1, as indicated by a 1 in row 1 and column 2 of matrix S' while item 1 is not recommended to user 1 or users in group 1, as indicated by a 0 in row 1 and column 1, whereas item 1 is recommended to user 2 or users in group 2, as indicated by the 1 in row 2 and column 1 while item 2 is not recommended to user 2 or users in group 2, as indicated by a 0 in row 2 and column 2.

### Example Operations for Automatically Recommending information With a Tunable Recommendation Distribution

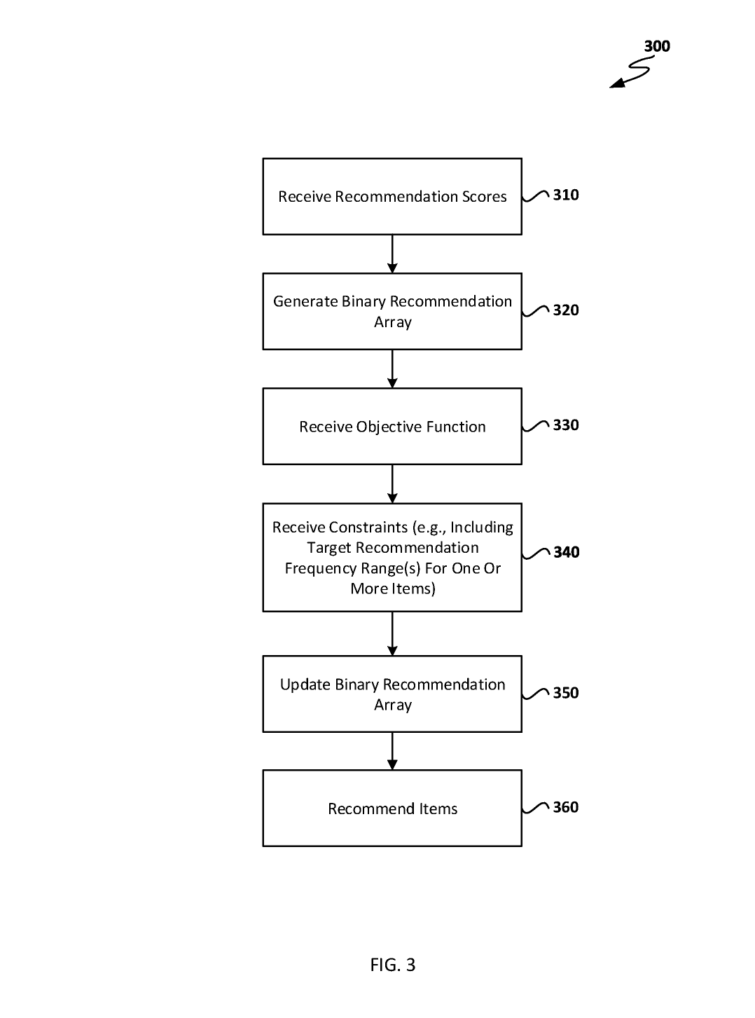

FIG. 3 is a flow diagram of example operations 300 for automatically recommending information with a tunable recommendation distribution. Operations 300 may be performed by an adjuster, such as adjuster 100 as illustrated in FIG. 1.

Operations 300 begin at 310, where recommendation scores of a plurality of items generated for a plurality of users using a recommender system based on one or more metrics is received, wherein the one or more metrics include a click through rate or an expected amount of purchase. For example, the recommendation scores can be recommendation scores 110 as illustrated in FIG. 1.

In some embodiments, one or more groups of the plurality of users are identified based on a set of attributes of the plurality of users or using a clustering algorithm, a particular group of users is then identified from the one or more groups, and recommendation scores corresponding to users not in the particular group of users are excluded from the recommendation scores, as discussed with respect to the optimization for a particular group with respect to FIG. 1.

In some embodiments, alternatively, one or more groups of the plurality of users are identified based on a set of attributes of the plurality of users or using a clustering algorithm, associated recommendation scores of the recommendation scores are aggregated for each group of the one or more groups, the recommendation scores are replaced with the aggregated recommendation scores, and an updated binary recommendation array associated with the group of users to which each user belongs is assigned to the user of the plurality of users, as discussed with respect to the optimization for aggregated groups with respect to FIG. 1.

In some embodiments, optimization for a particular group or for aggregated groups further includes sampling, for each group of the one or more groups of users, a subset of user, and excluding, for each group of the one or more groups of users, recommendation score corresponding to users not in the subset of users from the recommendation scores. Sampling can help reduce the complexity of the problem and save time and computational resources.

At 320, a binary recommendation array is generated based on the recommendation scores, wherein the binary recommendation array indicates whether or not to recommend the one or more items using binary recommendations. For example, the binary recommendation array can be generated by constructor 120 as illustrated in FIG. 1.

At 330, an objective function associated with the recommendation scores and the binary recommendation array is received. The objective function may specify to find a best alignment between the recommendation scores and the binary recommendation array. For example, the objective function can be objective function 112 as illustrated in FIG. 1.

In some embodiments, the objective function is configured to maximize a sum of products of the recommendation scores and respective binary recommendations in the binary recommendation array that are associated with the recommendation scores, such as the objective function as discussion with respect to problem 210 illustrated in FIG. 2.

At 340, a set of constraints associated with the plurality of users or the plurality of items is received. For example, the set of constraints can be constraints 114 as illustrated in FIG. 1. In some embodiments, the set of constraints comprises a target recommendation frequency range for an item of the plurality of items.

In some embodiments, the set of constraints include a number of items to be recommended to each user of the plurality of users. In certain embodiments, the target recommendation frequency range comprises a lower bound and an upper bound for a frequency with which the item is to be recommended to the plurality of users, such as the constraints as discussion with respect to problem 210 illustrated in FIG. 2. In some embodiments, the set of constraints comprises a respective target recommendation frequency range for each item of the plurality of items (e.g., each respective target recommendation frequency range including a respective lower bound and a respective upper bound) or for each of a subset of the plurality of items.

In such embodiments, the lower bound(s) and the upper bound(s) are scaled with respect to the number of items to be recommended, as discussed with respect to FIG. 1.

At 350, the binary recommendation array is updated based on evaluating the objective function subject to the set of constraints. The updated binary recommendation array may be a solution to an optimization problem, such as solution 220 as illustrated in FIG. 2. The optimization problem can be formulated based on the objective function and the set of constraints, such as problem 210 as illustrated in FIG. 2. The optimization problem can be solved by an optimizer, such as optimizer 122 as illustrated in FIG. 1.

In some embodiments, the binary recommendation array indicates at most one item to be recommended, and the optimizer further determines that two or more items of the plurality of items are to be recommended to each user, identifies a first updated binary recommendation, generates an additional constraint specifying that the first updated binary recommendation and its associated recommendation score are to remain zero, updates the binary recommendation array based on evaluating the objective function subject to the set of constraints and the additional constraint, identifies a second updated binary recommendation, and aggregates the first and second updated binary recommendation to generate the updated binary recommendations, as discussed with respect to FIG. 1.

At 360, one or more items of the plurality of items are recommended to each user of the plurality of users, based on the updated binary recommendation array. For example, the one or more items recommended can be items 130 as illustrated in FIG. 1.

### Example Application Server

FIG. 4 depicts an example application server 400, which can be used to deploy adjuster 100 of FIG. 1. As shown, application server 400 includes a central processing unit (CPU) 402, one or more input/output (I/O) device interfaces 404, which may allow for the connection of various I/O devices 414 (e.g., keyboards, displays, mouse devices, pen input, etc.) to application server 400, a network interface 406, a memory 408, a storage 410, and an interconnect 412.

CPU 402 may retrieve and execute programming instructions stored in memory 408. Similarly, CPU 402 may retrieve and store application data residing in memory 408. Interconnect 412 transmits programming instructions and application data, among CPU 402, I/O device interface 404, network interface 406, memory 408, and storage 410. CPU 402 is included to be representative of a single CPU, multiple CPUs, a single CPU having multiple processing cores, and the like. I/O device interface 404 may provide an interface for capturing data from one or more input devices integrated into or connected to application server 400, such as keyboards, mice, touchscreens, and so on. Memory 408 may represent a random access memory (RAM), while storage 410 may be a solid state drive, for example. Although shown as a single unit, storage 410 may be a combination of fixed and/or removable storage devices, such as fixed drives, removable memory cards, network attached storage (NAS), or cloud-based storage.

As shown, memory 408 includes adjuster 420. Adjuster 420 may be the same as or substantially similar to adjuster 100 of FIG. 1. Memory 408 further includes a recommender system 422, which may be any type of recommender system capable of generating recommendation scores 110 of FIG. 1, as discussed above. For example, recommender system 422 may be one or more of a collaborative filtering model, a content based filtering model, a reinforcement learning based model, and/or the like, and may have been trained to generate recommendation scores indicating likelihoods that one or more items are relevant to one or more users, such as based on historical data indicating items that are relevant to users.

As shown, storage 410 includes recommendation scores 430, objective function 432, and constraints 434. Recommendation scores 430 may be the same as or substantially similar to recommendation scores 110, objective function 432 may be the same as or substantially similar to objective function 112 while constraints 434 may be the same as or substantially similar to constraints 114 of FIG. 1.

It is noted that the components depicted in application server 400 are included as examples, and other types of computing components may be used to implement techniques described herein. For example, while memory 408 and storage 410 are depicted separately, components depicted within memory 408 and storage 410 may be stored in the same storage device or different storage devices associated with one or more computing devices.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with the language of the claims.

Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

What is claimed is:

1. A method, comprising:
receiving, for a plurality of users, recommendation scores of a plurality of items generated using a recommender system based on one or more metrics, wherein the one or more metrics include a click through rate or an expected amount of purchase;
generating a binary recommendation array based on the recommendation scores, wherein the binary recommendation array indicates whether or not to recommend the one or more items using binary recommendations;
receiving an objective function associated with the recommendation scores and the binary recommendation array;
receiving a set of constraints associated with the plurality of users or the plurality of items, wherein the set of constraints comprises a target recommendation frequency range for an item of the plurality of items;
updating the binary recommendation array based on evaluating the objective function subject to the set of constraints; and
recommending, to each user of the plurality of users, one or more items of the plurality of items based on the updated binary recommendation array.

2. The method of claim 1, wherein the objective function is configured to maximize a sum of products of the recommendation scores and respective binary recommendations in the binary recommendation array that are associated with the recommendation scores.

3. The method of claim 1, wherein the set of constraints comprises a number of items to be recommended to each user of the plurality of users.

4. The method of claim 3, wherein the target recommendation frequency range for the item comprises a lower bound and an upper bound for a frequency with which the item is to be recommended.

5. The method of claim 4, wherein the lower bound and the upper bound are scaled with respect to the number of items to be recommended.

6. The method of claim 1, further comprising:
identifying one or more groups of the plurality of users based on a set of attributes of the plurality of users or using a clustering algorithm;
identifying a particular group of users from the one or more groups; and
excluding recommendation scores corresponding to users not in the particular group of users from the recommendation scores.

7. The method of claim 1, further comprising:
identifying one or more groups of the plurality of users based on a set of attributes of the plurality of users or using a clustering algorithm;
aggregating, for each group of the one or more groups, associated recommendation scores of the recommendation scores;
replacing the recommendation scores with the aggregated recommendation scores; and
assigning, to each user of the plurality of users, an updated binary recommendation array associated with the group of users to which the user belongs.

8. The method of claim 7, further comprising:
sampling, for each group of the one or more groups of users, a subset of users; and
excluding, for each group of the one or more groups of users, recommendation score corresponding to users not in the subset of users from the recommendation scores.

9. The method of claim 1, wherein the binary recommendation array indicates at most one item to be recommended, and wherein the method further comprises:
determining that two or more items of the plurality of items are to be recommended to each user;
identifying a first updated binary recommendation;
generating an additional constraint specifying that the first updated binary recommendation and its associated recommendation score are to remain zero;
updating the binary recommendation array based on evaluating the objective function subject to the set of constraints and the additional constraint;
identifying a second updated binary recommendation; and
aggregating the first and second updated binary recommendation to generate the updated binary recommendations.

10. A system, comprising:
a memory including computer executable instructions; and
a processor configured to execute the computer executable instructions and cause the system to:
receive, for a plurality of users, recommendation scores of a plurality of items generated using a recommender system based on one or more metrics, wherein the one or more metrics include a click through rate or an expected amount of purchase;
generate a binary recommendation array based on the recommendation scores, wherein the binary recommendation array indicates whether or not to recommend the one or more items using binary recommendations;
receive an objective function associated with the recommendation scores and the binary recommendation array;
receive a set of constraints associated with the plurality of users or the plurality of items, wherein the set of constraints comprises a target recommendation frequency range for an item of the plurality of items;
update the binary recommendation array based on evaluating the objective function subject to the set of constraints; and
recommend, to each user of the plurality of users, one or more items of the plurality of items based on the updated binary recommendation array.

11. The system of claim 10, wherein the objective function is configured to maximize a sum of products of the recommendation scores and respective binary recommendations in the binary recommendation array that are associated with the recommendation scores.

12. The system of claim 10, wherein the set of constraints comprises a number of items to be recommended to each user of the plurality of users.

13. The system of claim 12, wherein the target recommendation frequency range for the item comprises a lower bound and an upper bound for a frequency with which the item is to be recommended.

14. The system of claim 13, wherein the lower bound and the upper bound are scaled with respect to the number of items to be recommended.

15. The system of claim 10, wherein the processor is further configured to execute the computer executable instructions and cause the system to:
identifying one or more groups of the plurality of users based on a set of attributes of the plurality of users or using a clustering algorithm;
identifying a particular group of users from the one or more groups; and
excluding recommendation scores corresponding to users not in the particular group of users from the recommendation scores.

16. The system of claim 10, wherein the processor is further configured to execute the computer executable instructions and cause the system to:
identifying one or more groups of the plurality of users based on a set of attributes of the plurality of users or using a clustering algorithm;
aggregating, for each group of the one or more groups, associated recommendation scores of the recommendation scores;
replacing the recommendation scores with the aggregated recommendation scores; and
assigning, to each user of the plurality of users, an updated binary recommendation array associated with the group of users to which the user belongs.

17. The system of claim 16, wherein the processor is further configured to execute the computer executable instructions and cause the system to:
sampling, for each group of the one or more groups of users, a subset of users; and
excluding, for each group of the one or more groups of users, recommendation score corresponding to users not in the subset of users from the recommendation scores.

18. The system of claim 10, wherein the binary recommendation array indicates at most one item to be recommended, and wherein the processor is further configured to execute the computer executable instructions and cause the system to:
determining that two or more items of the plurality of items are to be recommended to each user;
identifying a first updated binary recommendation;
generating an additional constraint specifying that the first updated binary recommendation and its associated recommendation score are to remain zero;
updating the binary recommendation array based on evaluating the objective function subject to the set of constraints and the additional constraint;
identifying a second updated binary recommendation; and
aggregating the first and second updated binary recommendation to generate the updated binary recommendations.

19. A non-transitory computer readable medium comprising instructions to be executed in a computer system, wherein the instructions when executed in the computer system cause the computer system to:
receive, for a plurality of users, recommendation scores of a plurality of items generated using a recommender system based on one or more metrics, wherein the one or more metrics include a click through rate or an expected amount of purchase;
generate a binary recommendation array based on the recommendation scores, wherein the binary recommendation array indicates whether or not to recommend the one or more items using binary recommendations;
receive an objective function associated with the recommendation scores and the binary recommendation array;
receive a set of constraints associated with the plurality of users or the plurality of items, wherein the set of constraints comprises a target recommendation frequency range for an item of the plurality of items;
update the binary recommendation array based on evaluating the objective function subject to the set of constraints; and
recommend, to each user of the plurality of users, one or more items of the plurality of items based on the updated binary recommendation array.

20. The non-transitory computer readable medium of claim 19, wherein the objective function is configured to maximize a sum of products of the recommendation scores and respective binary recommendations in the binary recommendation array that are associated with the recommendation scores.
